(19) United States
(12) Patent Application Publication
(10) Pub. No.: US 2017/0349763 A1
(43) Pub. Date: Dec. 7, 2017

(54) ANTI-CORROSION COMPOSITE LAYERS

(71) Applicant: Enerage Inc., Yilan County (TW)

(72) Inventors: Mark Y. Wu, Yilan County (TW); Cheng-Yu Hsieh, Yilan County (TW); Chun-Hsien Lee, Yilan County (TW); Jing-Ru Chen, Yilan County (TW); Shu-Ling Hsieh, Yilan County (TW)

(21) Appl. No.: 15/265,276

(22) Filed: Sep. 14, 2016

(30) Foreign Application Priority Data
Jun. 4, 2016 (TW) 105117744

(51) Int. Cl. C09D 5/08; B05D 7/00

(52) U.S. Cl. CPC C09D 5/084; B05D 7/50

(57) ABSTRACT

An anti-corrosion composite layer includes a first anti-corrosion coating coated on a substrate, and a second anti-corrosion coating coated on the first anti-corrosion coating. The first anti-corrosion layer includes a plurality of first graphene nanosheets and a first carrier resin, wherein a surface of each the first graphene nanosheet has a first lipophilic functional group for chemically bonding to the first carrier resin, the first lipophilic functional group is selected from carboxyl, epoxy and amino. The second anti-corrosion coating includes a plurality of second graphene nanosheets and a second carrier resin, wherein a surface of each the second graphene nanosheet has a second lipophilic functional group for chemically bonding to the second carrier resin, the second lipophilic functional group is selected from hydroxyl and isocyanic acid group.

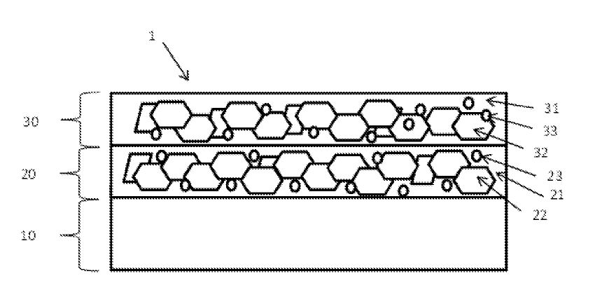

### CROSS-REFERENCE TO RELATED APPLICATION

This application claims the priority of Taiwanese patent application No. 105117744, filed on Jun. 4, 2016, which is incorporated herewith by reference.

### BACKGROUND OF THE INVENTION

### 1. Field of the Invention

The present application relates to an anti-corrosion composite layer, especially to an anti-corrosion composite layer constituted by combining a plurality of anti-corrosion coatings containing graphene nanosheets.

### 2. The Prior Arts

According to statistics, economic development of a nation has a close relation with corrosion of materials, and a global annual amount of loss due to the corrosion is incalculable. Although ratios of total corrosion caused losses in various nations accounting for their national economic production are not identical, all the corrosion caused losses amount are quite large, the corrosion caused losses cannot be ignored. In case of Taiwan, the area is surrounded by the sea, the products are easily affected by humid climate, salt of sea wind, and industrial pollutants, situation of the corrosion are very serious. In addition to the economic losses incurred by the corrosion itself, associated with the corrosion, indirect losses arising from issues of shutdown, losses increases of raw materials, electricity and heat are more tremendous.

Current anti-corrosion technology is nothing more than cathodic protection technique, anode protection technique, and anti-corrosion coating, wherein the anti-corrosion coating is the most common and widely used anti-corrosion technique. The most direct method of preventing corrosion of metal is to effectively isolate and block the factors of causing corrosion, so as to obviate the corrosion reaction. A mechanism of the anti-corrosion coating focuses on physically blocking the corrosion factors, such as blocking penetration of oxygen and moisture, to retard the corrosion rate, and thus to protect the metal. In general, special rust proofing paint are added in the vast majority of anti-corrosion coatings, when the anti-corrosion coating coated on the substrate exposes to moisture, the rust proofing paint will release inhibitory ions that can passivate cathode and anode of the metal substrate, so as to achieve the rust proofing effect; for example: red lead, zinc chrome yellow, zinc phosphate, aluminum triphosphate, the anti-corrosion properties of such nano-composites have been proven in many references.

Since Andre Geim and Konstantin Novoselov at University of Manchester in U.K. successfully obtained single layer graphene by utilizing tape to exfoliate graphite in 2004, and were awarded the Nobel Prize in Physics for 2010, electrical conductivity, thermal resistance, chemical resistance, and other excellent properties of the graphene are continuously applied to various fields by industries. The graphene mainly is a two-dimensional crystal structure of hexagonal honeycomb arrangement consisting of sp² hybrid orbital, a thickness thereof is only 0.335 nm, namely, a diameter size of a carbon atom. The graphene is the thinnest and strongest materials, a mechanical strength thereof can be hundreds times higher than steels, while a specific gravity thereof is only about a quarter of the steels. In addition, the graphene has very excellent impermeability and high surface area; such properties can effectively extend a path of the moisture and oxygen penetrating the polymer substrate, to reduce a permeability of the moisture and oxygen, so that the graphene can be applied to the anti-corrosion coating.

However, the most common problem in practice is that the graphene is very easy to aggregate, stack and cluster; namely, not easy to uniformly disperse. How to prevent the phenomenon of graphene sheets unevenly stacking on each other, to obtain graphene powder of high uniformity and less layers, always is the technical bottleneck that most needs to be solved in the industries.

CN patent publication No. 105086758A discloses a method of preparing a graphene anti-corrosion paint, which mainly uses a way of adding graphene to reduce zinc content in a zinc-rich paint. This graphene anti-corrosion paint need an equivalent anti-corrosion performance of the zinc-rich epoxy anti-corrosion paint, along with properties of acid/alkali proof, high hardness, good flexibility. However, a weight percentage of the graphene, zinc powder and filler accounting for an epoxy resin composition described in the patent application is up to 60 to 80%, in addition higher filler content probably leads to produce pores or channels of the resin that causes corrosion, poor affinity between the graphene and the filler probably causes a problem that the graphene cannot uniformly disperse in the resin, the zinc powder and the filler.

EP 2886616A1 discloses a non-chromium salt anti-corrosion paint, which is manufactured by adding graphene to replace a chromate corrosion inhibitor in the paint. However, the non-chromium salt anti-corrosion paint is a water base paint, anti-corrosion ability thereof is far worse than anti-corrosion performance of the common chromium salt anti-corrosion paints.

CN 104693976A discloses a multi-layer resistant corrosion coating system, which includes a first coating using polyester resin, and a second coating using polyvinylidene fluoride (PVDF) resin and acrylic resin, it meets demand of the resistant corrosion by properties of the multi-layer. However, such the multi-layer resistant corrosion system is manufactured by plural drying and curing steps; flatness of each cured coating relates to porosity between various coatings, and to an entire thickness of the multi-layer resistant corrosion coating. The porosity between the coatings affects weather and corrosion resistance abilities of the resistant corrosion coating; the multi-layer resistant coating having a larger entire thickness is not easy for processing; moreover, the multi-layer resistant corrosion coating still uses conventional rust proof paints, such as yellow iron oxide, zinc phosphate, chrome green, and other heavy metal paints, and thus has environmental pollution problems.

Additional, Japan patent publication No. 2002239455A discloses a method of forming a film by using a coating composition consisting of acrylic resin, epoxy resin and isocynate compound; however, such the film cannot completely suppress film deterioration that is caused by salt mist, so it cannot meet the corrosion resistance of severe use conditions.

How to solve the aforesaid problems, and to provide an anti-corrosion coating having high weather durability, which can meet the anti-corrosion demand even under harsh environment full of corrosion factors, are the main aspects of development of the present application.

### SUMMARY OF THE INVENTION

To achieve the above aspect, the present application provides an anti-corrosion composite layer including a first anti-corrosion coating and a second anti-corrosion coating. The first anti-corrosion coating is coated on a substrate, and includes a plurality of first graphene nanosheets and a first carrier resin, wherein a surface of each the first graphene nanosheet has a first lipophilic functional group for chemically bonding to the first carrier resin, the first lipophilic functional group is selected from carboxyl, epoxy and amino. The second anti-corrosion coating is coated on the first anti-corrosion coating, and includes a plurality of second graphene nanosheets and a second carrier resin, wherein a surface of each the second graphene nanosheet has a second lipophilic functional group for chemically bonding to the second carrier resin, the second lipophilic functional group is selected from hydroxyl and isocyanic acid group.

The first graphene nanosheets and the second graphene nanosheets, used in the present application, are fewer-layer or multi-layer graphene sheets, which have graphene purity greater than 95 wt %, thicknesses in a range of 1 nm to 20 nm, and plane lateral size in a range of 1 um to 100 um. Additionally, the first graphene nanosheets and the second graphene nanosheets are surface modified graphene nanosheets, whose surfaces have lipophilic functional groups corresponding to the first carrier resin and the second carrier resin, the lipophilic functional groups can allow the first graphene nanosheets and the second graphene nanosheets respectively and uniformly disperse in the first carrier resin and the second carrier resin, so that acid/alkali proof, corrosion resistance, shielding corrosion path and other properties of the graphene nanosheets can be fully exerted.

The first carrier resin and the second carrier resin, used in the present application, can be polymer resins, which can occur curing polymerization or crosslinking reactions at room temperature, and rate of the curing polymerization can also be increased at elevated temperature. Additionally, surfactants, assistant agents for controlling viscosity and processing, or a combination thereof can be further added in the first carrier resin and the second carrier resin. The assistant agents include diluents, plasticizers, crosslinking agents, adhesion promoters, fillers, leveling agents, metal surface treatment agents, thixotropic agent, initiators or catalysts.

The anti-corrosion coating added with the graphene has in addition to better anti-corrosion ability and mechanical strength, also has higher heat dissipation performance that can obviate coating deterioration of metal building materials, when the metal building materials are exposed outdoor and absorb too much heat. A combination of the properties of the surface modified graphene nanosheets and the carrier resin can enhance overall physical and chemical performances of the anti-corrosion coating, so as to achieve the objects of corrosion resistance, easy processing, high weather durability; therefore, the anti-corrosion composite layer of the present application has great potential in the industry application.

### BRIEF DESCRIPTION OF THE DRAWINGS

FIGURE is a cross-sectional view schematically illustrating an anti-corrosion composite layer of the present application.

### DETAILED DESCRIPTION OF PREFERRED EMBODIMENTS

The technical features and other advantages of the present application will become more readily apparent to those ordinarily skilled in the art, by referring the following detailed description of embodiments of the present application in conjunction with the accompanying drawing. In order to further clarify the technical means adopted in the present application and the effects thereof, the FIGURE schematically illustrates the relative relationship between the main elements, but is not based on the actual size; therefore, thickness, size, shape, arrangement and configuration of the main elements in the FIGURE are only for reference, not intended to limit the scope of the present application.

FIGURE is a cross-sectional view schematically illustrating an anti-corrosion composite layer of the present application. As shown in FIGURE, an anti-corrosion composite layer 1 mainly includes a first anti-corrosion coating 20 and a second anti-corrosion coating 30. The first anti-corrosion coating 20 is coated on the substrate 10, and includes a plurality of first graphene nanosheets 22 and a first carrier resin 21, wherein s surface of each the first graphene nanosheet 22 has a first lipophilic functional group for chemically bonding to the first carrier resin 21, the first lipophilic functional group can be selected from carboxyl, epoxy and amino. The second anti-corrosion coating 30 is coated on the first anti-corrosion coating 20, and includes a plurality of second graphene nanosheets 32 and a second carrier resin 31, wherein a surface of each the second graphene nanosheet 32 has a second lipophilic functional group for chemically bonding to the second carrier resin 31, the second lipophilic functional group can be selected from hydroxyl and isocyanic acid group.

In an embodiment, the anti-corrosion composite layer 1 further includes a first filler 23 added in the first anti-corrosion coating 20, and a second filler 33 added in the second anti-corrosion coating 30. The plurality of first graphene nanosheets 22 and the first filler 23 uniformly disperse in the first carrier resin 21 to form a web-like shielding structure, the plurality of second graphene nanosheets 32 and the second filler 33 uniformly disperse in the second carrier resin 31 to form a web-like shielding structure. Specifically, a weight percentage of the plurality of first graphene nanosheets 22 accounting for the first anti-corrosion coating 20 is 0.01-5 wt %, a weight percentage of the first filler 23 accounting for the first anti-corrosion coating 20 is 0.1-20 wt %; a weight percentage of the plurality of second graphene nanosheets 32 accounting for the second anti-corrosion coating 30 is 0.01-10 wt %, a weight percentage of the second filler 33 accounting for the second anti-corrosion coating 30 is 5-50 wt %.

It is noted that each the first graphene nanosheets 22 and each the second graphene nanosheets 32 in FIGURE are shown on side directions of the sheet shape to facilitate an explanation of the technical features of the present application; namely, from an actually viewing angle in the FIGURE, a part of the first graphene nanosheets 22 and the second graphene nanosheets 32 will show their front surfaces, and a part of the first graphene nanosheets 22 and the second graphene nanosheets 32 will simultaneously show portions of their front surfaces and portions of their side surfaces.

The substrate 10 can be a metal or alloy substrate having a processed surface and conforming to Swedish standard SIS Sa 2½ above, such as a galvanized steel plate.

In details, the plurality of first graphene nanosheets 22 and the plurality of second graphene nanosheets 32 have bulk densities in a range of 0.1 to 0.001 g/cm³, thicknesses in a range of 1 to 20 nm, plane lateral sizes in a range of 1 to 100 um, a ratio of the plane lateral sizes to the thicknesses is in a range of 20 to 10000, and specific surface areas in a range of 15 to 750 m²/g, and oxygen contents in a range of 1 to 20 wt %. Particle sizes of the first filler 23 and the second filler 33 are 2 to 5000 times of the thicknesses of the first graphene nanosheets 22 and the second graphene nanosheets 32.

The first graphene nanosheet 22 and the second graphene nanosheet 32 respectively have at least a surface modified layer having a chemical structure of Mx(R)y(R′)z, in which M represents a metal element selected from at least one of aluminum, titanium, zirconium and silicon, 0≦x≦6, 1≦y≦20, and 1≦z≦20, R represents a hydrophilic OH functional group for generating a chemical bonding between the first graphene nanosheets 22 of the first anti-corrosion coating 20 and the second graphene nanosheets 32 of the second anti-corrosion coating 30, R′ represents a lipophilic functional group for generating a chemical bonding to the first carrier resin 21 and the second carrier resin 31.

Specifically, R′ is selected from at least one of alkoxy, carbonyl, acyloxy, amido, isocyanic acid group, aliphatic carbonyl, aliphatic hydroxyl, cyclohexane group, acetyl and benzoyl.

Oxygen contents of the first graphene nanosheets 22 and the second graphene nanosheets 32 are in a range of 1-20 wt %.

The first carrier resin 21 and the second carrier resin 31 can be selected from high functional thermosetting resin; specifically, from at least one of polymethylmethacrylate, polyethylene terephthalate, polyurethane, polyacrylamide, polymethtlacrylate, polyvinylacetate, epoxy resin, polytetramethylene glycol diacrylate, bismalemide, cyanate ester, polycarbonate, ethylene based resin, cellulose acetate, cellulose acetate butyrate, cellulose acetate propionate, ethyl cellulose, phenolic resin, carboxymethyl cellulose, polyolefin and silicon resin. Further, the first carrier resin 21 and the second carrier resin 31 are preferably selected from at least one of polyurethane, epoxy, and phenolic resin.

The first filler 23 and the second filler 33 can be selected from titanium dioxide based powder, silicate based powder, carbonate based powder, aluminosilicate based powder, or a combination thereof.

The anti-corrosion composite layer 1 can further includes at least an assistant agent added in the first anti-corrosion coating 20 and/or the second anti-corrosion coating 30, for example: a surfactant, a dedicated diluting solvent, a metal surface treatment agent and a coupling agent, for adjusting properties of processing, weather resistance, chemical resistance and adhesion of the first anti-corrosion coating 20 and the second anti-corrosion coating 30. In the anti-corrosion composite layer 1, function orientations of the first anti-corrosion coating 20 and the second anti-corrosion coating 30 are not exactly the same, in terms of the first anti-corrosion coating 20, a main function thereof is in addition to provide anti-corrosion, another function is to provide a strong adhesion, to allow the anti-corrosion composite layer tightly adhere to the substrate 10; in terms of the second anti-corrosion coating 30, a main function thereof is in addition to provide anti-corrosion, it further needs to provide excellent mechanical strength such as abrasion resistance, hardness and weather resistance, to allow the anti-corrosion composite layer 1 have excellent lifetime, so that the anti-corrosion composite layer 1 does not easily lose anti-corrosion performance due to harsh environment.

The surfactant has functions of wetting and adjusting compatibility of various raw materials between coatings, it also can effectively improve surface flatness of a film formed by the coatings. The surfactant can be selected from at least one of saturated fatty acid, unsaturated fatty acid and polyunsaturated fatty acid, wherein the saturated fatty acid includes at least one of stearic acid, lauric acid, palmitic acid and myristic acid; the unsaturated fatty acid includes at least one of palmitoleic acid and oleic acid, and the polyunsaturated fatty acid includes at least one of linoleic acid and linolenic acid.

The dedicated diluting solvent can be selected from at least one of aromatics, esters, ether alcohols and ketones. To add an appropriate amount of a metal surface treatment agent in the dedicated diluting solvent can effectively improve adhesion of the coating directly applied to slightly corroded metal, the metal surface treatment agent can be selected from at least one of paraethylamine, diethylamine, triethylamine, diamylamine, naphthylamine, phenylnaphthylamine, ethanolamine, diethanolamine, triethanolamine, benzotriazole, hydroxybenzotriazole, hexamethylenetetramine and sodium alginate.

The coupling agent has a chemical structure represented by Mx(R)y(R′)z, in which M represents a metal element selected from aluminum, titanium, zirconium and silicon, R represents a hydrophilic functional group selected from sulfonates, R′ represents a lipophilic functional group selected from isocyanic acid group, 0≦x≦6, 1≦y≦20, and 1≦z≦20; the hydrophilic functional group and the lipophilic functional group are used for generating a chemical bonding between the first graphene nanosheets 22 and the first carrier resin 21, and/or between the second graphene nanosheets 32 and the second carrier resin 31. When the first graphene nanosheets 22 (or the second graphene nanosheets 32) has a smaller specific surface area, an amount of the lipophilic functional groups on its modified surface is insufficient, and the bonding and dispersibility between the first graphene nanosheets 22 (or the second graphene nanosheets 32) and the first carrier resin 21 (or the second carrier resin 31) are thus affected, the coupling agent can adjust the amount of lipophilic functional groups to solve the problem of insufficient lipophilic functional groups. The coupling agent includes, but not limit to, silanes, titanates, zirconates, aluminum zirconates and alumivates.

In order to show the specific effects of the anti-corrosion composite layer of the present application, to make those ordinarily skilled in the art further know overall operation, the actual operation will be described in detail with the following exemplary embodiments.

### Surface Modified Graphene Nanosheets

The surface modified graphene nanosheets are used in all following exemplary embodiments, the surface modification step includes sub steps of functionalizing the graphene nanosheets, and forming a surface modified layer. The sub step of forming the surface modified layer is to further react the functionalized graphene nanosheets with the coupling agent, to form the surface modified layer on surfaces of the functionalized graphene nanosheets, a chemical structure of the coupling agent is Mx(R)y(R′)z, in which M represents a metal element selected from aluminum, titanium, zirconium and silicon, 0≦x≦6, 1≦y≦20, R is a hydrophilic OH functional group for forming chemical bonds with the first graphene nanosheets of the first anti-corrosion coating and the second graphene nanosheets of the second anti-corrosion coating; R′ represents a lipophilic functional group for forming chemical bonds with the first carrier resin of the first anti-corrosion coating and the second carrier resin of the second anti-corrosion coating. An oxygen content of the surface modified graphene nanosheet is in a range of 1-20 wt %.

It is worthy to mention that the coupling agent can be selected corresponding to various characteristics of the carrier resins, to react with the graphene nanosheets to form the surface modified layer. The hydrophilic OH function group of the coupling agent can chemically bond to the surface (such as functional groups COOH, OH) of the functionalized graphene nanosheets, and the lipophilic functional groups of the coupling agent can form chemical bonding with the carrier resin through the surface modified layer; thereby, the graphene nanosheets can uniformly disperse in the carrier resin, and the graphene nanosheets uniformly dispersed in the carrier resin are sufficient to fully exert the physical and chemical characteristics of the graphene nanosheets, for example: shielding ability, wear resistance, electrical conductivity, thermal resistance, chemical resistance, so as to enhance the performance of the anti-corrosion layer.

### Substrate

The galvanized steel is used as the substrate in all the following exemplary embodiments. After the galvanized steel is polished with sandpaper progressively to #1200 level, the surface of galvanized steel is cleaned by using deionized water and alcohol; then, a paint is sprayed on the substrate by a way of gas spraying, the substrate sprayed with the paint is cut into strip samples of 10 mm×10 mm×1 mm, and the cut gap is sealed with an epoxy resin; then, the samples are dried with air, and the samples are packaged on fixtures to perform an electrochemical test. The electrochemical test utilizes three-electrode system, wherein a working electrode is the sample, an auxiliary electrode is a platinum electrode, and a reference electrode is a silver/silver chloride electrode. A polarization curve of the sample is determined by using a cyclic voltammetry (CV), and then a corrosion current of the sample is found through the polarization curve.

### Dedicated Diluting Solvent

A recipe of the dedicated diluting solvent includes N-butyl acetate of 25 wt %, diethylene glycol ether acetate of 15 wt %, isophorone of 13 wt %, ethyl methyl ketone of 10 wt %, xylene of 35 wt %, the metal surface treatment agent of 0.5 wt %, a dehydrant of 1.5 wt %. The aforesaid recipe is stirred with blades, at a rotation speed of 150 rpm, for 60 minutes, to be uniformly mixed.

### Exemplary Embodiment 1

A recipe includes an epoxy resin of 62 wt %, the dedicated diluting solvent of 24.5 wt %, calcium carbonate of 1.5 wt %, kaolinite of 1 wt %, talc of 1 wt %, titanium dioxide of 3 wt %, a surfactant of 6 wt %, the surface modified graphene nanosheets of lwt %. In this exemplary embodiment, the surface of graphene nanosheets is modified by using a silane, one end of the silane is hydrolyzed to form an OH functional group that bonds to the surface of graphene nanosheets, another end of the silane is a first lipophilic functional group that is selected to chemically bond to the epoxy resin, the first lipophilic functional group is carboxyl, epoxy group or amino.

Firstly, the recipe of exemplary embodiment 1 is pre-mixed according to the recipe proportion, and then is uniformly mixed by using a planetary high speed mixer at a revolution speed of 2000 rpm and a spin speed of 400 rpm for 90 minutes, to obtain a paint containing the graphene nanosheets. Then, the paint containing the graphene nanosheets is coated on the galvanized steel by the way of gas spraying. Then, the paint is heated with an oven or a hot plate to be cured, at 130° C. for 30 minutes, to form a desired first anti-corrosion coating.

### Exemplary Embodiment 2

A recipe includes an epoxy resin of 62 wt %, the dedicated diluting solvent of 23.5 wt %, calcium carbonate of 1.5 wt %, kaolinite of 1 wt %, talc of 1 wt %, titanium dioxide of 3 wt %, a surfactant of 6 wt %, the surface modified graphene nanosheets of 2 wt %. In this exemplary embodiment, the surface of graphene nanosheets is modified by using a silane, the surface of graphene nanosheets have the first lipophilic functional group for chemically bonding to the epoxy resin, the first lipophilic functional group is carboxyl, epoxy group or amino.

Firstly, the recipe of exemplary embodiment 2 is pre-mixed according to the recipe proportion, and then is uniformly mixed by using a planetary high speed mixer at a revolution speed of 2000 rpm and a spin speed of 400 rpm for 90 minutes, to obtain a paint containing the graphene nanosheets. Then, the paint containing the graphene nanosheets is coated on the galvanized steel by the way of gas spraying, and a thickness of the paint is about 30 μm. Then, the paint is heated with an oven or a hot plate to be cured, at 130° C. for 30 minutes, to form a desired first anti-corrosion coating.

### Exemplary Embodiment 3

A recipe includes a polyurethane resin of 80.5 wt %, calcium carbonate 4 wt %, kaolinite 2.3 wt %, talc 2.3 wt %, titanium dioxide 8.3 wt %, a surfactant 1.6 wt %, the surface modified graphene nanosheets of 1 wt %. In this exemplary embodiment, the surface of graphene nanosheets is modified by using a silane, the surface of graphene nanosheets have the second lipophilic functional group for chemically bonding to the polyurethane resin, the second lipophilic functional group is hydroxyl or isocyanic acid group.

Firstly, the recipe of exemplary embodiment 3 is pre-mixed according to the recipe proportion, and then is uniformly mixed by using a planetary high speed mixer at a revolution speed of 2000 rpm and a spin speed of 400 rpm for 90 minutes, to obtain a paint containing the graphene nanosheets. Then, the paint containing the graphene nanosheets is coated on the galvanized steel by the way of gas spraying, and a thickness of the paint is about 30 μm. Then, the paint is heated with an oven or a hot plate to be cured, at 130° C. for 30 minutes, to form a desired second anti-corrosion coating.

### Exemplary Embodiment 4

A recipe includes a polyurethane resin of 79.5 wt %, calcium carbonate 4 wt %, kaolinite 2.3 wt %, talc 2.3 wt %, titanium dioxide 8.3 wt %, a surfactant 1.6 wt %, the surface modified graphene nanosheets of 2 wt %. In this exemplary embodiment, the surface of graphene nanosheets is modified by using a silane, one end of the silane is hydrolyzed to form an OH functional group that bonds to the surface of graphene nanosheets, another end of the silane is a second lipophilic functional group that is selected to chemically bond to the polyurethane resin, the second lipophilic functional group is hydroxyl or isocyanic acid group.

Firstly, the recipe of exemplary embodiment 4 is pre-mixed according to the recipe proportion, and then is uniformly mixed by using a planetary high speed mixer at a revolution speed of 2000 rpm and a spin speed of 400 rpm for 90 minutes, to obtain a paint containing the graphene nanosheets. Then, the paint containing the graphene nanosheets is coated on the galvanized steel by the way of gas spraying, and a thickness of the paint is about 30 μm. Then, the paint is heated with an oven or a hot plate to be cured, at 130° C. for 30 minutes, to form a desired second anti-corrosion coating.

The anti-corrosion coatings of above exemplary embodiments 1-4 are applied to the galvanized steel in a cross-combination, and their adhesion and anti-corrosion abilities are tested in comparison with a comparative example that does not add the graphene. The thickness of all the coatings is 30 μm. The adhesion of coatings are tested by the hundred grid test (cross cut test), and the anti-corrosion abilities of coatings are tested by an electrochemical method, that places the galvanized steel coated with the anti-corrosion layer in a 5% sodium chloride solution, to simulate corrosion effect. The test results are shown in table 1.

TABLE 1

| | | | | A total | |
|---|---|---|---|---|---|
| | | | | amount of | |
| | The first anti- | The second anti- | Corrosion | graphene of | Hundred |
| | corrosion | corrosion | current | the composite | grid |
| | coating | coating | (μA) | layer (wt %) | test |
| Exemplary | Exemplary | Exemplary | 0.276 | 2 | 100 |
| embodiment 5 | embodiment 1 | embodiment 3 | | | |
| Exemplary | Exemplary | Exemplary | 0.185 | 3 | 100 |
| embodiment 6 | embodiment 1 | embodiment 4 | | | |
| Exemplary | Exemplary | Exemplary | 0.193 | 3 | 100 |
| embodiment 7 | embodiment 2 | embodiment 3 | | | |
| Exemplary | Exemplary | Exemplary | 0.163 | 4 | 100 |
| embodiment 8 | embodiment 2 | embodiment 4 | | | |
| Comparative | — | — | 104 | 0 | 100 |
| example | | | | | |

Due the density of corrosion current is proportional to the corrosion rate, the smaller corrosion current represents the lower corrosion rate and the better anti-corrosion effect. As shown in table 1, the corrosion current of the anti-corrosion composite layer that has added the graphene nanosheets is far less than the coating not adding the graphene. When the first anti-corrosion coating combines the second anti-corrosion coating, the difference therebetween can be discovered from the measurement of corrosion current. In comparison with the test results of Exemplary embodiments 5 and 6, the percentage of graphene added in the second anti-corrosion coating is increased, and the corrosion current can be further reduced. In comparison with the test results of Exemplary embodiments 6 and 7, although the total percentage of graphene added in the anti-corrosion composite layer are the same, the measured corrosion current of Exemplary embodiment 6 is lower than the measured corrosion current of Exemplary embodiment 7, the reason is that the graphene nanosheets contained in the second anti-corrosion coating can effectively shield the corrosion current, so as to obviate that the corrosion current directly penetrates the anti-corrosion composite layer, then contact the substrate. Therefore, the second anti-corrosion coating has the graphene of more percentage, and it has the better anti-corrosion effect. Additionally, from the result of Exemplary embodiment 8, with increasing the graphene percentage of the first anti-corrosion coating and the second anti-corrosion coating, the corrosion current will further reduce, so as to achieve the better anti-corrosion effect.

Further, the anti-corrosion composite layer of Exemplary embodiment 8 performs an abrasion Resistance test, an adhesion test, a pencil hardness test and a Quv test (weather resistance), in comparison with the comparative example that does not add the graphene. The test results are shown in table 2.

TABLE 2

| | |
|---|---|
| Comparative | Exemplary |
| example | embodiment 8 |

| | | | | |
|---|---|---|---|---|
| Abrasion Resistance test | 0.98 | mg | 0.49 | mg |
| Adhesion test | 800 | psi | 800 | psi |

| | | |
|---|---|---|
| Pencil hardness test | 2H | 4H |

| | | | | |
|---|---|---|---|---|
| Quv test | 100 | hour | 3000 | hour |

As shown in table 2, to add the graphene nanosheets in the anti-corrosion coating not only effectively enhance the anti-corrosion ability of the anti-corrosion coating, but also obviously increase the mechanical strength of the anti-corrosion coating; moreover, the adhesion of the coating to the substrate has no impact, and the abrasion value of the coating is significantly reduced; especially, the second anti-corrosion coating mainly contacts with the external environment, so the enhanced mechanical characteristics such as adhesion, abrasion resistance, weather resistance of the anti-corrosion composite layer can lengthen the lifetime of the anti-corrosion composite layer, that makes it have more industrial applications.

Additionally, the anti-corrosion composite layer of the present application can be formed by mixing the surface modified graphene nanosheets, the resins, the fillers, and other optional additives, the way of mixing is to use an apparatus, for example: planetary high speed mixer, high shear dispersion apparatus, ultrasonic vibration apparatus that can uniformly mix materials. Therefore, it is no need to use special apparatus with additional design to meet the demand of manufacturing the anti-corrosion composite layer containing the graphene nanosheets, so that the economy of reducing cost can be achieved, and the competitiveness of products on the market can be enhanced.

Moreover, a surface of the galvanized steel, that the anti-corrosion composite layer is not coated thereon, of Exemplary embodiment 8 connects to a thermal source (for example: LED of 10 watts), and performs a heat diffusion test, in comparison with the comparative example not adding the graphene. The test results are shown in table 3.

TABLE 3

| | Comparative | Exemplary |
|---|---|---|
| | example | embodiment 8 |
| Temperature of the heat | 85.8° C. | 85.1° C. |
| source | | |
| Temperature of the anti- | 85.1° C. | 70.7° C. |
| corrosion composite layer | | |
| Temperature difference | 0.7° C. | 14.4° C. |
| Heat diffusion | — | 16.9% |
| performance | | |

As shown in table 3, in addition to better anti-corrosion ability and mechanical strength, the anti-corrosion composite layer containing the graphene has the enhanced heat diffusion performance, so as to obviate excessive heat absorption causing deterioration of the anti-corrosion composite layer, when the metal building materials are exposed outdoor. In general, in combination with the characteristics of the surface modified graphene nanosheets and the carrier resins can comprehensively enhance the physical and chemical characteristics of the anti-corrosion composite layer, so as to achieve the aspects of anti-corrosion, easy processing, low cost, and high weather resistance; therefore, the anti-corrosion composite layer of the present application has great potential of industrial applications.

The exemplary embodiments described above only illustrate the principles and effects of the present application, but are not intended to limit the scope of the present application. Based on the above description, an ordinarily skilled in the art can complete various similar modifications and arrangements according to the technical programs and ideas of the present application, and the scope of the appended claims of the present application should encompass all such modifications and arrangements.

What is claimed is:

1. An anti-corrosion composite layer, comprising:
a first anti-corrosion coating, coated on a substrate, and comprising a plurality of first graphene nanosheets and a first carrier resin, wherein a surface of each the first graphene nanosheet has a first lipophilic functional group for chemically bonding to the first carrier resin, the first lipophilic functional group is selected from carboxyl, epoxy and amino; and
a second anti-corrosion coating, coated on the first anti-corrosion coating, and comprising a plurality of second graphene nanosheets and a second carrier resin, wherein a surface of each the second graphene nanosheet has a second lipophilic functional group for chemically bonding to the second carrier resin, the second lipophilic functional group is selected from hydroxyl and isocyanic acid group.

2. The anti-corrosion composite layer according to claim 1, wherein a pencil hardness of the second anti-corrosion coating is ≧4H.

3. The anti-corrosion composite layer according to claim 1, wherein a weight percentage of the plurality of second graphene nanosheets is greater than or equal to a weight percentage of the plurality of first graphene nanosheets, based on a total weight of the anti-corrosion composite layer.

4. The anti-corrosion composite layer according to claim 1, wherein a weight percentage of the plurality of first graphene nanosheets accounting for the first anti-corrosion coating is 0.01-5 wt %.

5. The anti-corrosion composite layer according to claim 1, wherein a weight percentage of the plurality of second graphene nanosheets accounting for the second anti-corrosion coating is 0.01-10 wt %.

6. The anti-corrosion composite layer according to claim 1, wherein the plurality of first graphene nanosheets and the plurality of second graphene nanosheets have bulk densities in a range of 0.1 to 0.001 g/cm³, thicknesses in a range of 1 to 20 nm, plane lateral sizes in a range of 1 to 100 um, specific surface areas in a range of 15 to 750 m²/g, and oxygen contents in a range of 1 to 20 wt %.

7. The anti-corrosion composite layer according to claim 1, wherein the first carrier resin is selected from at least one of epoxy resin and phenolic resin.

8. The anti-corrosion composite layer according to claim 1, wherein the second carrier resin is selected from at least one of polyurethanes and hydroxylacrylic resins.

9. The anti-corrosion composite layer according to claim 1, further comprising at least one of a filler, a surfactant, a dedicated diluting solvent and a coupling agent, added in the first anti-corrosion coating and/or the second anti-corrosion coating.

10. The anti-corrosion composite layer according to claim 9, wherein the filler is selected from a titanium dioxide based powder, a silicate based powder, a carbonate based powder, an aluminosilicate based powder, or a combination thereof; a particle size of the filler is in a range of 2 to 5000 times thicknesses of the first graphene nanosheet or the second graphene nanosheet.

11. The anti-corrosion composite layer according to claim 10, wherein the filler comprises a first filler added in the first anti-corrosion coating, a weight percentage of the first filler accounting for the first anti-corrosion coating is 0.1-20 wt %.

12. The anti-corrosion composite layer according to claim 10, wherein the filler comprises a second filler added in the second anti-corrosion coating, a weight percentage of the second filler accounting for the second anti-corrosion coating is 5-50 wt %.

13. The anti-corrosion composite layer according to claim 9, wherein the surfactant is selected from at least one of saturated fatty acid, unsaturated fatty acid and polyunsaturated fatty acid.

14. The anti-corrosion composite layer according to claim 9, wherein the dedicated diluting solvent is selected from at least one of aromatics, esters, ether alcohols and ketones.

15. The anti-corrosion composite layer according to claim 14, wherein the dedicated diluting solvent, added in the first anti-corrosion coating, further comprises at least a metal surface treatment agent selected from phosphates, dichromates, and oxides thereof.

16. The anti-corrosion composite layer according to claim 9, wherein the coupling agent has a chemical structure represented by Mx(R)y(R′)z, in which M represents a metal element selected from aluminum, titanium, zirconium and silicon, R represents a hydrophilic functional group selected from sulfonates, R′ represents a lipophilic functional group selected from isocyanic acid group, 0≦x≦6, 1≦y≦20, and 1≦z≦20; the hydrophilic functional group and the lipophilic functional group are used for generating a chemical bonding between the first graphene nanosheet and the first carrier resin, and/or between the second graphene nanosheet and the second carrier resin.
